(19) United States
(12) Patent Application Publication
(10) Pub. No.: US 2018/0044977 A1
(43) Pub. Date: Feb. 15, 2018

(54) ROLLING DOOR CONSTRUCTION FOR CONTROLLING AIR LEAKAGE

(71) Applicant: Raynor Mfg. Co., Dixon, IL (US)

(72) Inventors: Joel M. Bonnell, Dixon, IL (US); Matthew S. Reutzel, Prophetstown, IL (US)

(21) Appl. No.: 15/630,069

(22) Filed: Jun. 22, 2017

Related U.S. Application Data
(60) Provisional application No. 62/374,329, filed on Aug. 12, 2016.

(51) Int. Cl. E06B 9/17; E06B 9/15; E06B 9/58

(52) U.S. Cl. CPC E06B 9/17076; E06B 9/582; E06B 9/15; E06B 2009/17084; E06B 2009/588

(57) ABSTRACT

An overhead, rolling door includes a peripheral seal construction that restricts air flow heat transfer through the periphery of a door opening. The door comprises a flexible curtain mounted on an overhead drum located above the door opening. The curtain may be unwound from the drum and lowered to close the door opening and engages the seal to preclude air flow energy loss through the door opening. The seal is comprised of unitary, elastomeric, elongate, flexible blades mounted on brackets positioned around the periphery of the door opening. The blades function as flexible cantilever mounted seals with an outer end that fits tightly against the surface of the closed door to form an uninterrupted seal of the closed door opening.

### CROSS REFERENCE TO RELATED APPLICATION

This is a utility application based on provisional application Ser. No. 62/374,329 filed Aug. 12, 2016 entitled “Rolling Door Construction for Controlling Air Leakage for which priority is claimed.

### BACKGROUND OF THE INVENTION

In a principal aspect the present invention relates to overhead, rolling door constructions which incorporate a seal assembly to control leakage of air flow through the periphery of a door opening when the door opening is closed by the door construction.

The International Energy Conservation Code (IECC) is a model building code initiated by the International Code Counsel (ICC) in 2000. Many states and municipal governments in the United States adopted the model code which sets forth minimum building design and construction requirements to promote energy efficiency. The United States Department of Energy has been instrumental in proposing building codes to the ICC designed to achieve the goals of the IECC.

A recent publication of IECC code proposals is directed to the requirement of limiting air leakage through openings closed by doors, windows and the like. Various standards are set forth in the proposed code sections based on the type of fenestration or opening which is involved, the type of doors or closure devices that are affected and various other scientific and engineering factors. The standards and goals that are set with respect to IECC code provide builders, manufacturers of products and others with guidance regarding functional parameters that are considered to achieve energy conservation goals. As such, manufacturers, contractors and others have developed techniques designed to meet the code standards. Such techniques include the following representative patents:

| PATENT NO. | ISSUE DATE | TITLE |
|---|---|---|
| 4,357,978 | Nov. 9, 1982 | Roller Shade Seal System |
| 5,201,530 | Apr. 13, 1993 | Multi-Layered Brush Seal |
| 5,205,334 | Apr. 27, 1993 | Double Layer Shade |
| 5,445,209 | Aug. 29, 209 | Guide System for Vertically |
| | | Moveable Flexible Door |
| 6,129,130 | Oct.10, 2000 | Door Edge Debris Block and |
| | | Air Seal |
| 6,152,279 | Nov. 28, 2000 | Strip Barrier Brush Assembly |
| 6,425,472 | Jul. 30, 2002 | Strip Barrier Brush Assembly |
| 6,595,344 | Jul. 22, 2003 | Strip Barrier Brush Assembly |
| 7,086,442 | Aug. 8, 2006 | Garage Screen Door System |
| 8,505,923 | Aug. 13, 2013 | Brush Seal with Stress and |
| | | Deflection Accommodating |
| | | Membrane |
| 8,882,050 | Nov. 11, 2014 | Railway Track and Switch |
| | | Weather Protection Barrier |
| | | System |
| 9,068,655 | Jun. 30, 2015 | Quick Change Brush Seal |
| | | Retaining Arrangement |
| 9,140,363 | Sep. 22, 2015 | Brush Seal Cover Assembly |
| PUBLICATION NO. | PUBLICATION DATE | TITLE |
| 2003/0096114 | May 22, 2003 | Method of Fabricating a |
| | | Non-Hollow Fiber Having a |
| | | Regular Polygonal Cross- |
| | | Section |
| 2008/0309017 | Dec. 18, 2008 | Environmental Brush Seal |
| 2010/0083581 | Apr. 8, 2010 | Environmental Brush Seal |
| 2015/0082704 | Mar. 26, 2015 | Roll-Up Door Seal |
| 2015/0197985 | Jul. 16, 2015 | Overhead Door With Lintel |
| | | Seal Interface System |
| EP 1 213 435 A2 | Jun. 12, 2001 | Roller Shutter Box |
| EP 2 290 266 B1 | Sep. 19, 2012 | Brush Seal with Stress and |
| | | Deflection Accommodating |
| | | Membrane |

While such disclosures are considered helpful, there remains the need to provide designs and constructions, particularly of doors used in combination with larger openings that will exhibit improved energy efficiency characteristics and restriction of heat loss through building openings such as doors and windows.

### SUMMARY OF THE INVENTION

Briefly, the present invention is directed to an overhead, rolling door seal construction which restricts air flow, through the periphery of an opening closed by the rolling door. Overhead rolling doors are a type of door wherein a flexible curtain serves as a closure for the door opening. The curtain is designed to be flexible so that it can be wound on a drum or shaft positioned over the top or header of a door opening. Typically the curtain is fabricated from a combination of various materials designed to unfold from an overhead storage drum construction and be guided downward by channels or slots affixed to door jambs on opposite sides of the door opening as the closure curtain is lowered. Leakage through or around the edges of the closure panel or curtain may result in undesirable air and heat flow from or into the structure forming the door opening.

The present invention comprises a mechanism wherein the door jambs and a header form a door opening in combination with a base pad or floor. A flexible curtain mounted on an overhead drum or mandrel or shaft is typically fully wound on the drum or shaft or mandrel to open the door and may be unwound from the drum to close the door opening. Features which are included in order to preclude air flow and energy loss through the door opening include elastomeric, elongate blades mounted on rigid plates or brackets positioned around the periphery of the door opening. The blades function as seals that are flexible with an outer end that fits against the surface of the closed door. The blades include an inner end affixed to the assembly of brackets and plates mounted on the door jambs and header that define the door opening.

Thus, the elastomeric blades project as cantilever extensions from the brackets with their outer edges aligned, both vertically and horizontally, so that the blades will uniformly and continuously engage the surface of the curtain thereby forming a peripheral seal that provides a flexible coplanar sealing edge positioned against the surface of the closed door curtain which has been lowered into place to cover the opening. By choosing appropriate material to form the cantilever projecting blades in combination with the design and construction of the blade mounting brackets, a coplanar relationship of the outer sealing edges of the blades is maintained for cooperative engagement with a surface of the curtain that is lowered to close the opening. The blades thus comprise a unique shape, dimensional profile, flexibility and hardness to effect sealing of a closed door.

Thus, it is an object, aspect and feature of the invention to provide an improved seal construction which precludes air flow through the sides of a rolling curtain door when the door is in the closed position.

A further aspect of the invention is to provide an easily installed and maintained sealing system for a rolling door construction of the type wherein the door is maintained on an overhead drum and is positioned to close the door opening upon unwinding from the drum.

Yet another object, advantage and feature of the invention is to provide a door seal construction or assembly which can be customized depending upon the size and configuration of a door.

Another object, aspect and feature of the invention is to provide a sealing assembly in a kit form to accommodate overhead rolling doors of various sizes and materials.

An additional object of the invention is to provide a sealing assembly for an overhead rolling door which is easily installed, repaired, reasonably priced, and durable.

These and other objects, advantages and features of the invention are set forth in a detailed description of an embodiment of the invention as follows.

### BRIEF DESCRIPTION OF THE DRAWING

In the detailed description which follows, reference will be made to the drawing comprised of the following figures:

FIG. 1 is a front elevation view of a rolling overhead door which employs the subject matter of the invention;

FIG. 2 is a sectional view of the door of FIG. 1 taken along the line 2-2;

FIG. 3 is a sectional view of a roller curtain mounted in a drum depicting the manner in which the curtain is positioned within the drum and engaged by a seal;

FIG. 4 is a schematic sectional view of the roller curtain of FIG. 3 depicting a baffle feature;

FIG. 5 is a sectional detail view of the slat assembly of the roller curtain;

FIG. 6 is an exploded partial perspective view of the rolling door construction depicting the various sealing assembly components;

FIG. 7 is a side elevation of a bracket member utilized in combination with a seal for mounting on the header of a door opening;

FIG. 8 is a sectional view of a seal used in combination with the bracket of FIG. 7 to provide a seal along the header of a rolling door;

FIG. 9 is a sectional view of the combination of a seal of FIG. 8 with the bracket of FIG. 7;

FIG. 10 is a sectional view of the seals supported by the guides of the door opening;

FIG. 11 is a detail sectional view of the brackets and seal of the assembly of FIG. 10;

FIG. 12 is a detail sectional view depicting the floor seal assembly for the bottom edge of the rolling door guide assembly with a floor or planar surface; and

FIG. 13 is a perspective detail view of an edge seal incorporated along the bottom edge of the rolling door to provide a seal against the floor of the door opening.

### DESCRIPTION OF AN EMBODIMENT OF THE INVENTION

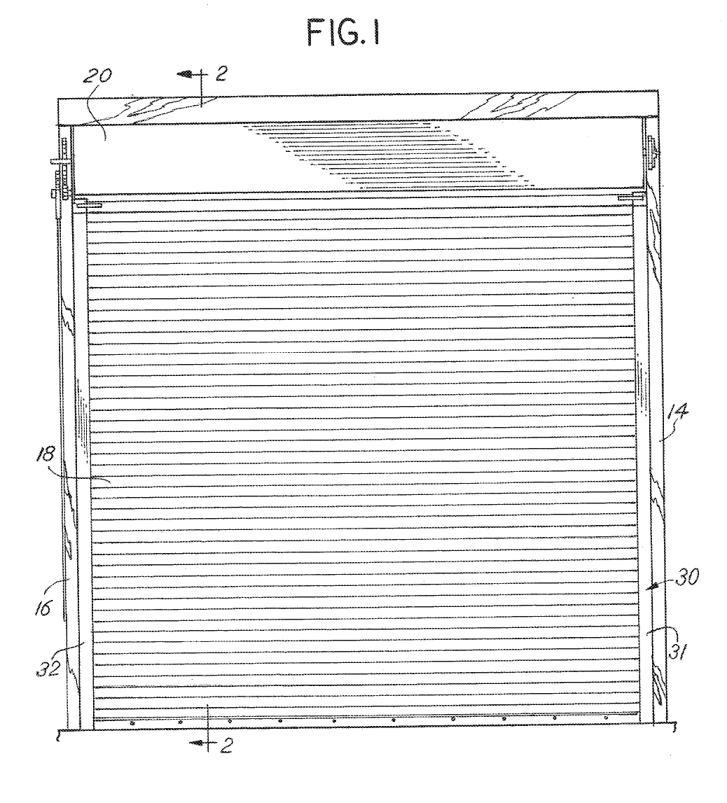

Referring to the figures there is depicted an opening 10 in a building construction. FIGS. 1, 2, 6 and 10 depict the inclusion of a building door opening 10 incorporating a roller door assembly embodiment of the invention. The opening 10 is typically comprised of a frame including a header 12 horizontally extending across the top of the opening 10 connected to or joined to first and second, spaced lateral vertical side jambs 14 and 16. The jambs 14 and 16 are typically parallel to one another and perpendicular to the header or head 12. The opening 10 is further bounded by a floor 15 which is typically horizontal and generally parallel to the header 12 at the top of the opening 10.

A rolling door curtain 18 is mounted on a drum 19 in a housing 20. The housing 20 is mounted on the header 12 above the opening 10. The drum 19 includes a rotatable mandrel or shaft 22 extending between opposite side walls of the drum 19. The shaft or mandrel 22 of the drum 19 is typically powered to rotate about an axis 21 and thereby lower or raise the flexible curtain 18. The drum 19 and curtain 18 exceed the width of the opening 10 and are typically mounted on the inside or outside structure comprising the opening 10. Thus, the curtain 18 is designed to cover the opening 10 when the curtain 18 is lowered by unwinding the curtain 18 mounted on the shaft 22 in the housing 20. A flexible hood baffle 11 affixed at one end to a semi-cylindrical curtain restrainer is biased against the curtain 18 wound on drum 19.

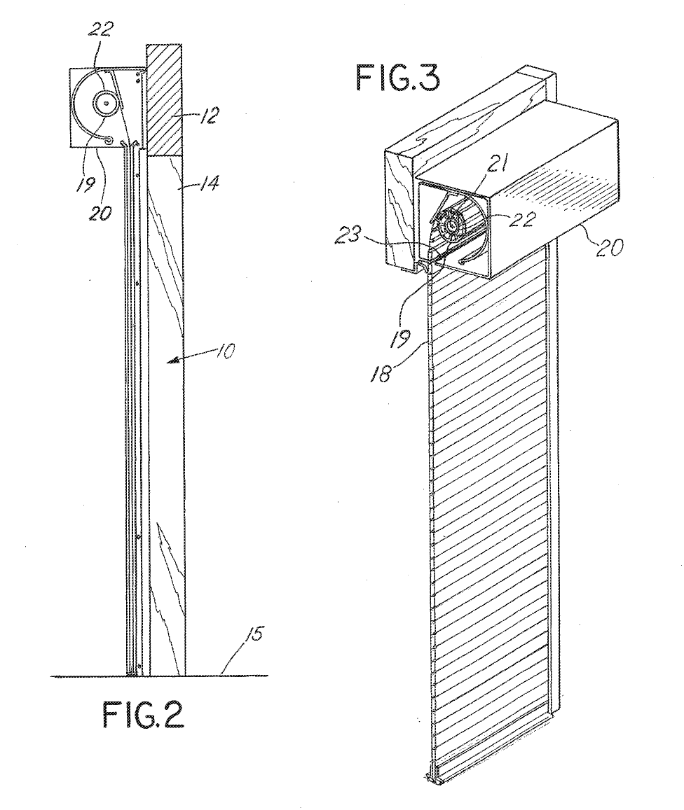

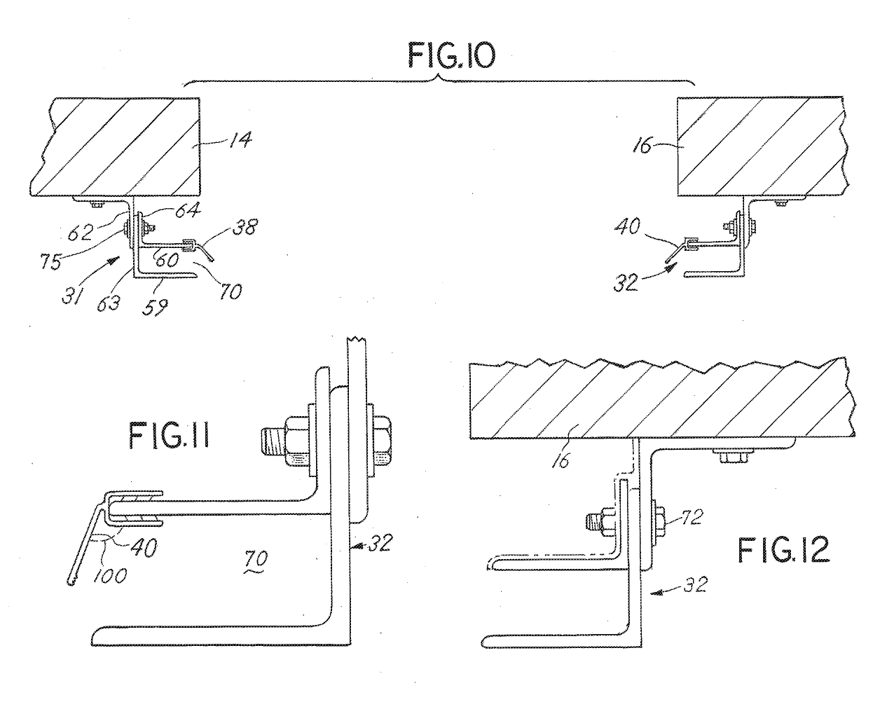

Referring to FIGS. 3 and 5, the curtain 18 may be comprised of articulating or hinged segments 26 which enable the curtain 18 to be flexed or articulated and wound on the drum 19. The hinge segments 26 are typically longitudinal panels or elements of narrow width joined together by flexible hinge elements 27, 28 so that the segments 26 may articulate one with respect to the other. The elements, e.g., 27, 28 may be formed as tubular with an insulating material core. This configuration and assembly of the curtain 18 enables the top side of the curtain 18 to be affixed to the shaft or mandrel 22 and wound onto that shaft or mandrel 22. The drum 19 is sized so that it will easily receive the fully wound curtain 18 on the drum 19. The curtain 18 is thus protected within the drum 19 and may exit through a slot 23 along the bottom edge of the drum 19. The curtain 18 may include additional aspects or features such as a layer of a flexible sheet or fabric material 29 affixed thereto to facilitate the closure and also facilitate preclusion of air flow through the curtain between the segments 26. As depicted in FIGS. 1 and 2 the curtain 18 is sized to be lowered from the drum 19 so that it will cover the entire opening 10 and extend beyond the lateral side edges or jambs 14, 16 of the opening 10. The vertical dimension of the curtain 18 is greater than the vertical height of the opening 10. FIG. 10 is a sectional view which depicts vertical curtain assembly of the component parts for guiding the curtain 18 slidably into spaced, first and second vertical slotted track assemblies 31, 32 affixed respectively to the spaced jambs 14 and 16. The vertical guide assemblies 31, 32, mounted on the vertical spaced jambs 14, 16, provide a means to guide the curtain 18 as it is downloaded from the drum 19 so that the curtain 18 will be sealed against and cover the side edges of the opening 10.

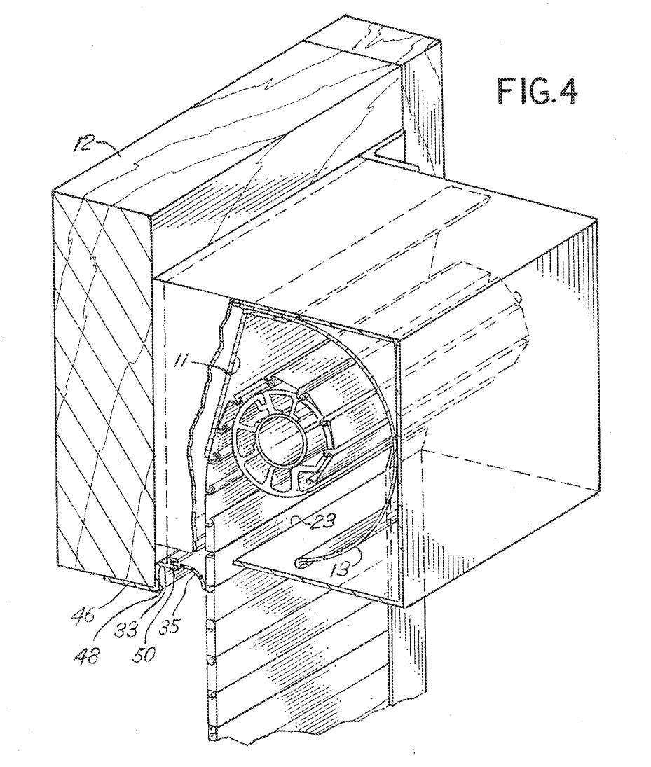

A transverse or horizontal seal assembly comprising a bracket 33 and seal 35 is attached to the header 12 as depicted in FIG. 4. The header, transverse, bracket assembly, comprised of flexible seal 35 and retainer bracket 33, is designed to support the flexible transverse seal member 35 positioned against the face of the curtain 18 and thereby seal the top of the curtain 18 so that air flow may not pass outwardly between the curtain 18 and the opening 10. The transverse seal 35 attached to the header 12 and the vertical guide assemblies 31, 32, which support laterally projecting seals 38, 40 attached respectively thereto, provide a seal arrangement wherein flexible seal members 35, 38, 40 attached respectively to the transverse bracket 33 and to the first and second vertical guide assemblies 31, 32 are positioned to preclude air flow between the closed curtain 18 and the opening 10. The seals 35, 38, 40 associated respectively with the transverse bracket 33 and with the vertical guide assemblies 31, 32 are comprised of substantially the same seal material such as a vinyl material and are mounted to provide seal engagement along the face of curtain 18 along the entire periphery of the vertical sides of the curtain 18 and the top of the curtain 18. FIG. 10 depicts in a sectional view the positioning of the vertical, curtain channel guide slot brackets 31, 32 and the associated seal 38, 40 constructions.

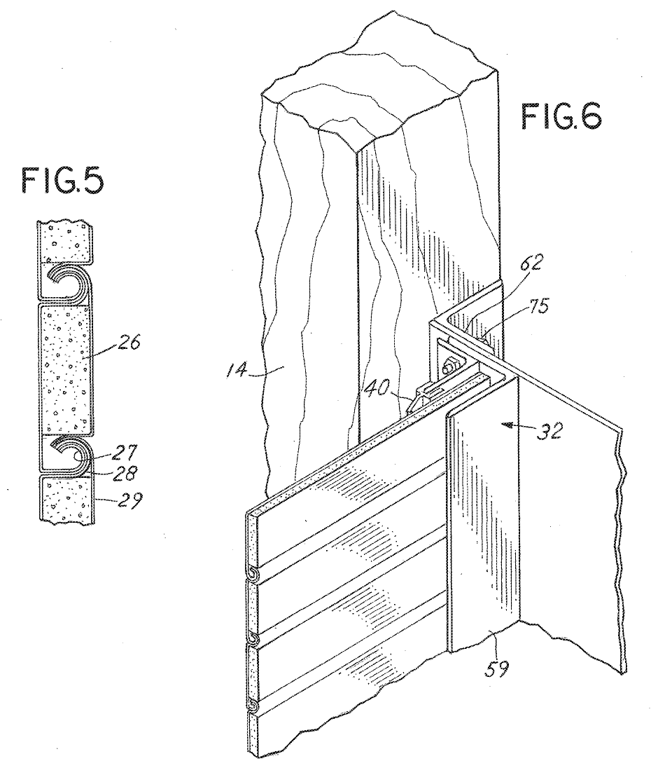

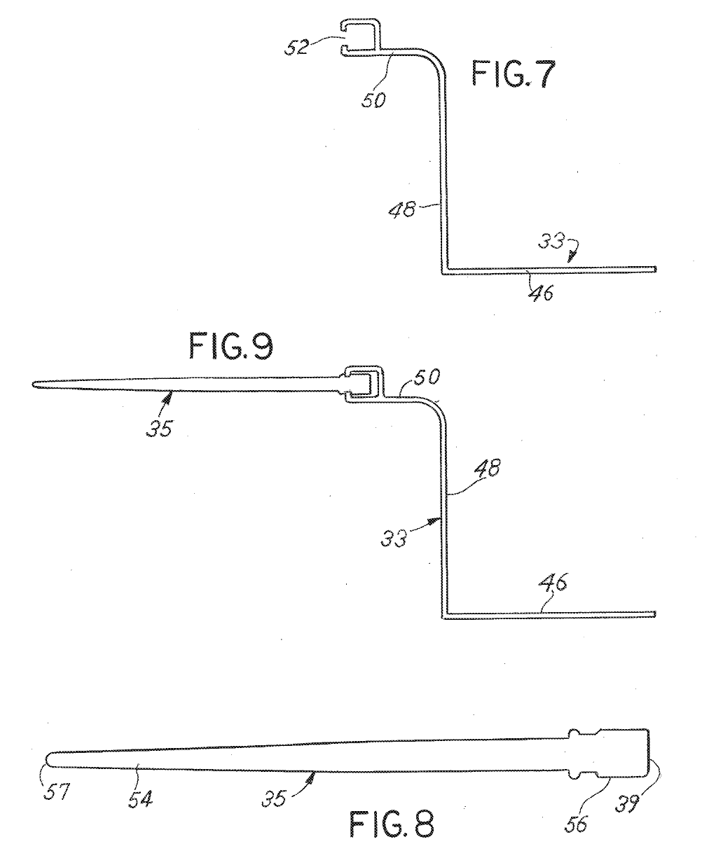

Referring again to FIG. 4, the transverse bracket assembly 33 including seal 35 is attached to the header 12. FIGS. 7, 8 and 9, depict the seal 35 in greater detail. Referring to FIGS. 6 and 10, the first and second lateral side seal assemblies 31, 32 associated with the side jambs 14, 16 are depicted in a sectional view. Additionally, a horizontal floor seal assembly 42, associated with the lower or bottom edge 44 of the curtain or rolling door 18, is depicted in FIG. 13.

Referring therefore to FIGS. 4, 7, 8 and 9, the transverse header bracket 33 is affixed to the header 12. The bracket 33 is typically made from a metal extrusion and has a cross section configuration which includes a first generally horizontal section or plate 46 connected at a right angle to a vertical run or plate 48 that, in turn connects at a right angle to a lateral run or plate 50 having a recess opening 52 incorporated at the distal end thereof. The various plates or sections 46, 48, 50 of the bracket 33 may be adjustable or pre-manufactured to provide for different extensions of the outwardly extending seal 35 support run or cantilever extension 50. The seal support run 50 is configured to cooperate with seal 35 as depicted in FIG. 8. The seal 35 includes an elongate, tapered, flexible elastomeric section 54 coupled to an attachment configured end section 56 designed to cooperate with and be retained by the seal retention slot or opening 52 of bracket 33. The combination of these two components, bracket 33 and seal 35, is depicted in FIG. 9.

FIGS. 7, 8 and 9 are thus illustrative of the construction of a unitary, generally constant cross section header seal bracket assembly. Varied structure design features may be employed with respect to these component parts. For example, the configuration and extent of the various runs or sections of the header bracket 33 may be customized for a particular opening size and construction and header configuration. The configuration of the seal retention pocket 52 may be customized for cooperation with the seal coupling end or section 56. The seal 35 may have a customized configuration and may be provided in adjustable lengths between an attachment end 57 and the distal outer end 39. Importantly, the seal 35 is flexible and may vary in length depending upon the width of the header opening 10 that is to be closed. Thus, the header seal assembly employs a constant cross section along the horizontal length thereof extending beyond the width of the door opening 10.

FIG. 4 illustrates in detail the manner in which the bracket and seal assembly 33, 35, attached to the header 12, interacts with the curtain 18. That is, the seal 35 projects from the pocket 52 of the support bracket 33 and extends outwardly so that the flexible end 57 of the seal 35 may be engaged by the curtain 18 as the curtain descends from the drum 19 through the slot 23 as it is discharged from the drum 19. Because of the choice of the length of the seal 35 and the fact that it is positioned above the opening 10 at the entry of the curtain 18 in opposition to the opening 10, the seal 35 will flex in a manner which augments the effect of the seal 35. That is, the seal 35 is thus biased or compressed against the curtain 18 surface to enhance the ability of the seal 35 to preclude undesired air flow through the opening 10 between the curtain 18 and the header 12.

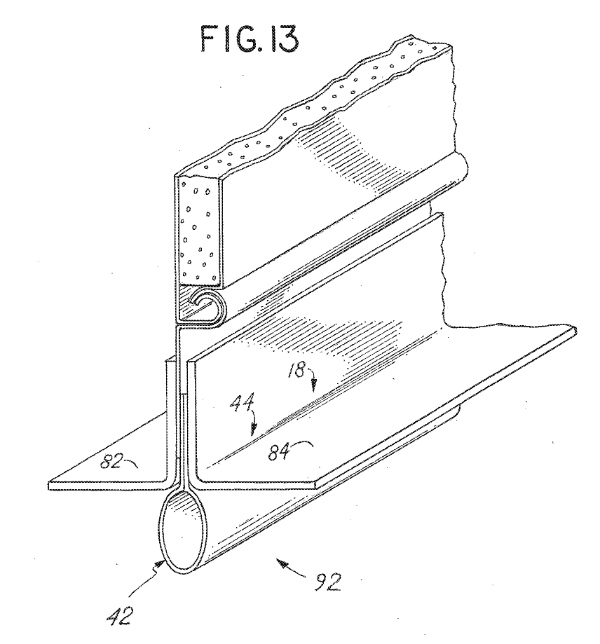

FIGS. 6, and 10-12 depict the design of the vertical seal assemblies comprised of brackets and channel members 31, 32 with attached lateral side seals 38, 40 that engage the outside face of the curtain 18. The vertical seal and bracket assemblies comprise generally mirror images of one another positioned on opposite lateral sides of the opening 10. Specifically, in the embodiment depicted, each vertical guide seal bracket 31, 32 is comprised of three L-shaped cross section members 59, 60, 62. The first bracket member 59 and the second bracket member 60 each include a leg section 63, 64 respectively which fit one against the other to provide a space 70 for receipt of the sliding curtain 18. The first and second section members 59, 60 thus are designed to extend from the floor 15 to above the top of the opening 10 in opposition to a jamb 14 or 16. The section members flare outwardly and diverge to end 23 to receive the curtain 18. A third attachment bracket member 62 is also L-shaped and has one leg 63 thereof fixed to a jamb 14 or 16 and a second leg 64 coupled with the bracket, channel members 59, 60 comprising the curtain channel 70. Importantly, the members 59, 60 defining the channel 70 are uninterrupted and extend from the floor 15 to the region above the opening 10. The support bracket 62 is fastened to the other bracket assembly members 59, 60 joined by a fastener 75. But support bracket or brackets 62 need not extend the entire distance or space between the floor 15 to the header 12, however, the channel bracket does extend the full height of the opening and appropriately above the opening height so that seals 38, 40 will seal against header seal 35 when the door is closed.

The bracket member 60 of the vertical bracket assembly include respectively the seal members 38, 40 attached thereto and projecting to engage the sliding door curtain 18. It is to be noted that outer edge 78 of the seal members 38, 40 associated with the vertical brackets as well as the seal member 35 supported by the header bracket 33 lie in a single plane to provide a complete peripheral seal against the door 18 when closed.

As an additional feature of the invention, a floor seal 42 depicted in FIG. 13 is provided along the bottom edge 44 of the curtain 18. Typically the floor seal 42 is a flexible elastomeric material such as a neoprene tubular material retained in position by first and second, back-to-back facing L-shaped brackets 82, 84 which facilitate squeezing on the floor seal 42 when the door or curtain 18 is lowered.

Variations include positioning the rolling door on the inside or outside of the frame. Multiple seals may be arrayed in parallel on the header and jambs along the periphery thereof for engagement with the rolling door in the closed position. Multiple flexible seal materials may be utilized. The seals may incorporate multiple outer end or tip constructions to enhance the sealing function.

While an embodiment of the invention is set forth herein, the invention is limited only by the following claims and equivalents thereof.

What is claimed is:

1. An air flow leakage restriction assembly for combination with a rolling door panel mounted in a frame opening of a structure, said opening separating a first structure side from a second structure side, said opening bounded by a top header, a first lateral side jamb, a second lateral side jamb spaced from the first jamb and a floor spaced from the header, said leakage restriction assembly comprising, in combination:
a first lateral guide channel mounted on the first structure side of the opening on the first jamb for receipt of a first side of said door panel in a closed door position, said first guide channel including a first elongate panel guide plate extending from the floor upwardly above the frame opening;
said first elongate guide plate including a first flexible, elongate side seal member mounted on and projecting from the first elongate guide plate for sealingly engaging the door in the closed position between the floor and above the frame opening to restrict air flow through the frame opening between the first structure side and the second structure side;
a second lateral guide channel mounted on the first structure side of the frame opening on the second jamb for receipt of a second opposite side of said door panel opposite said first side of said door panel in a closed door panel position, said second guide channel including a second elongate panel guide plate extending from the floor upwardly above the frame opening;
said second elongate guide plate including a second flexible, elongate side seal member mounted on and projecting from the second elongate guide plate for sealingly engaging the door in the closed position between the floor and above the frame opening to restrict the air flow through the frame opening between the first structure side and the second structure side; and
a header seal support bracket plate mounted on the header on the first structure side of the frame opening and extending generally at least between opposite lateral sides of the frame opening, said seal support bracket including a flexible, elongate header seal member mounted on the header seal support bracket, said header seal, said first side seal member, and said second side seal member in combination positioned for continuously sealingly engaging the door panel in the closed position,
said first side seal member, said second side seal member and said header seal member in combination positioned for and capable of at least partially sealing air flow between the first structure side and the second structure side with the door panel in the closed position,
each of said seal members comprising a unitary cantilever extension of a unitary elastomeric material in the form of a blade having an inner edge section, a generally parallel outer edge, said inner edge section sealingly attached to and retained by the corresponding support plate to form a flexible extension of each said seal member spaced from the inner edge, and wherein the side seal members and the header seal member each have a generally uniform cross sectional, flexible configuration.

2. The assembly of claim 1 wherein the seal members extend generally uniformly from the inner edges thereof to the outer edges thereof to form a continuous peripheral, uninterrupted seal between a closed door panel and the seal members.

3. The assembly of claim 2 including brackets for said seal members configured and sized to maintain the outer edges substantially coplanar.

4. The assembly of claim 1 wherein said seal members each have an outer edge thickness less than a thickness of the inner edge.

5. The assembly of claim 1 wherein flexible seal members have a uniform cross section.

6. The assembly of claim 1 wherein first and second guide plate channels are comprised of first and second, generally parallel, spaced legs forming a said channel for receipt of a lateral side of said door panel, with one of said legs comprising a said guide plate with said flexible seal attached thereto.

7. The assembly of claim 1 further including a floor seal member mounted along a lower edge of the door panel.

8. The assembly of claim 7 wherein the lower edge door panel seal member comprises an elastomeric member mounted at the lower side of the door panel between the opposite, lateral sides of the door panel.
